(19) United States
(12) Patent Application Publication
(10) Pub. No.: US 2016/0326408 A1
(43) Pub. Date: Nov. 10, 2016

(54) MOISTURE CURABLE HOT MELT ADHESIVE WITH HIGH ADHESION STRENGTH AND FAST SET TIME

(71) Applicant: Henkel lP & Holding GmbH, Duesseldorf (DE)

(72) Inventors: Wu Suen, Flemington, NJ (US); Charles W. Paul, Madison, NJ (US)

(21) Appl. No.: 14/707,042

(22) Filed: May 8, 2015

(51) Int. Cl. C09J 123/26; C09J 5/00; C09J 133/12

(52) U.S. Cl. CPC C09J 123/26; C09J 133/12; C09J 5/00; C09J 2201/61; C09J 2433/00; C09J 2423/00; C09J 2451/00

(57) ABSTRACT

The present invention relates to isocyanate free, moisture curable hot melt adhesive compositions having improved green strength, the production of such adhesives and the use of such adhesives.

### FIELD OF THE INVENTION

This invention relates to isocyanate free, moisture curable hot melt adhesive compositions and the use of such adhesives.

### BACKGROUND OF THE INVENTION

A hot melt adhesive composition is solid at room temperature and, upon application of heat, the hot melt adhesive composition melts to a liquid or fluid state in which molten form it is applied to a substrate. On cooling, the adhesive composition regains its solid form. The hard phase(s) formed upon cooling the adhesive composition impart all of the cohesion (strength, toughness, creep and heat resistance) to the final bond. Hot melt adhesive compositions are thermoplastic and can be heated to a fluid state and cooled to a solid state repeatedly. Hot melt adhesive compositions do not include water or solvents.

Curable or reactive hot melt adhesive compositions are a class of hot melt adhesives. They are also solid at room temperature and, upon application of heat, melt to a liquid or fluid state in which molten form they are applied to a substrate. On cooling, the adhesive composition regains its solid form. The hard phase(s) formed upon cooling the adhesive composition and prior to curing impart initial or green strength to the bond. The adhesive composition will cure by a chemical crosslinking reaction upon exposure to suitable conditions such as exposure to moisture. Before curing the adhesive composition remains thermoplastic and can be remelted and resolidified. Once cured, the adhesive composition is in an irreversible solid form and is no longer thermoplastic. The crosslinked adhesive composition provides additional strength, toughness, creep and heat resistance to the final bond. Reactive hot melt adhesive compositions can provide higher strength and heat resistance compared to thermoplastic hot melt adhesive compositions. Reactive hot melt adhesive compositions do not include water or solvents.

The ability of a reactive hot melt adhesive composition to cool so that the solidified but non-crosslinked composition can quickly bond parts together is called green strength. An adhesive composition that quickly develops green strength is desirable in commercial operations as it allows bonded parts to be further processed quickly. After solidification reactive hot melt adhesive compositions will continue to react with moisture so that strength of the adhesive bond between parts will continue to rise. A high cured strength is desirable in commercial operations as it allows stressed parts to be bonded.

The majority of reactive hot melt adhesives are moisture-curing urethane hot melt compositions. The reactive components of urethane hot melt compositions consist primarily of isocyanate terminated polyurethane prepolymers containing urethane groups and reactive isocyanate groups that react with surface or atmospheric moisture to chain extend and form a new polyurethane polymer. Polyurethane prepolymers are conventionally obtained by reacting diols with diisocyanates.

Moisture-curing urethane hot melt adhesive compositions have certain disadvantages. One disadvantage is the residual monomer content of polyisocyanates, more particularly the more volatile diisocyanates, used to prepare the isocyanate terminated polyurethane prepolymers. Some moisture-curing urethane hot melt adhesive compositions can contain significant amounts of unreacted monomeric diisocyanates. At the hot melt application temperature (typically at 90° C. to 170° C.) the unreacted monomeric diisocyanates contained in a urethane hot melt adhesive composition have a considerable vapor pressure and may be partly expelled in gaseous form. The isocyanate vapors may be toxic, irritating and have a sensitizing effect, so that precautionary measures have to be taken in the application process. Hot melt adhesives containing unreacted isocyanate are not used for some applications such as roll coating. This hazard is further aggravated in roll coating applications as large surface exposure area is involved during laminating process.

Silane reactive hot melt adhesive compositions have been developed to replace isocyanate reactive hot melt compositions. Silane reactive hot melt adhesive compositions are also solid at room temperature and, upon application of heat, melt to a liquid or fluid state in which molten form they are applied to a substrate. On cooling, the composition regains its solid form. Silane reactive hot melt adhesive compositions are based on silane modified polymers that comprise moisture reactive silane groups that form siloxane bonds when exposed to moisture such as in the atmosphere. Silane reactive hot melt adhesive compositions offer good cured adhesion and since there is no isocyanate there are no concerns about emission of isocyanate monomer vapor. Silane reactive hot melt adhesive compositions typically do not contain water or solvent. However, some silane reactive hot melt adhesive compositions develop green strength slower than reactive polyurethane hot melt adhesive compositions and have lower adhesion to many substrates than reactive polyurethane hot melt adhesive compositions.

There remains a need for a silane reactive hot melt adhesive composition that has a desirable combination of properties for commercial use including quick development of green strength, a long working life and high final (cured) adhesion.

### BRIEF SUMMARY OF THE INVENTION

Disclosed in one embodiment is a silane reactive hot melt adhesive composition comprising a silane functional polyolefin; a functional wax; and optionally one or more of catalyst; tackifier; reactive plasticizer; adhesion promoter; acrylic polymer; and other additives. The silane reactive hot melt has good adhesion and is free of isocyanate monomers.

Disclosed in one embodiment is a silane reactive hot melt adhesive composition comprising a silane functional polyolefin; a silane modified reactive plasticizer; a tackifier; and optionally one or more of catalyst; functional wax; reactive plasticizer; adhesion promoter; and other additives. The silane reactive hot melt has surprisingly improved properties compared to the same silane reactive hot melt adhesive without the silane functional polyolefin.

Disclosed in one embodiment is a method for bonding materials together which comprises applying the silane reactive hot melt adhesive composition in a molten form to a first substrate, bringing a second substrate in contact with the molten composition applied to the first substrate, and subjecting the applied composition to conditions which will allow the composition to cool and cure to an irreversible solid form, said conditions comprising moisture.

Disclosed in one embodiment is an article of manufacture comprising a substrate bonded to cured reaction products of the silane reactive hot melt adhesive composition.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure and understanding the concept and embodiments disclosed herein, a person of ordinary skill can, without inventive effort, explore beyond the disclosed limits and, when embodiments are found to be without any unexpected characteristics, those embodiments are within the meaning of the term about as used herein.

### DETAILED DESCRIPTION OF THE INVENTION

The disclosures of all documents cited herein are incorporated in their entireties by reference.

As used herein, “irreversible solid form” means a solid form wherein the silane reactive hot melt adhesive composition has reacted with moisture to produce a cured, thermoset, insoluble material. As used herein ambient conditions are a temperature of about 23 to 25° C. and relative humidity of about 50%.

The silane reactive hot melt adhesive composition comprises one or more silane functional polyolefins. Silane functional polyolefins comprise a polyolefin backbone with silane moieties attached thereto. The silane moieties may be pendent to the polyolefin backbone, terminal to the polyolefin backbone, or both. The silane moieties are reactive, that is they can react under certain conditions to bond to surfaces or crosslink to other polymer chains. Useful classes of silane functional polyolefins include, e.g., silane functional amorphous polyalphaolefins and silane functional metallocene catalyzed polyolefins. In some embodiments the silane functional polyolefin is free of urethane bonds.

Useful silane functional amorphous polyalphaolefins are derived from amorphous polyalphaolefin and a silane source. Useful amorphous polyalphaolefins include homopolymers, copolymers and terpolymers of olefins including, e.g., atactic polypropylene, atactic poly-1-butene and combinations thereof. The amorphous polyalphaolefins can be random or block copolymers. Other suitable amorphous polyalphaolefin polymers include, e.g., homogeneous substantially linear ethylenealphaolefin interpolymers derived from monomers including, e.g., propylene, 1-butene, 1-pentene, 3-methyl-1-butene, 1-hexene, 3-methyl-1-pentene, 4-methyl-1-pentene, 3-ethyl-1-pentene, 1-octene, 1-decene, and 1-undecene; amorphous copolymers with other olefins (e.g., ethylene, 1-butene, -pentene, 1-hexene, 4-methyl-1-pentene, 1-octene, and 1-decene) containing propylene as a major component, amorphous copolymers with other olefins (e.g., ethylene, propylene, 1-pentene, 1-hexene, 4-methyl-1-pentene, 1-octene, and 1-decene) containing 1-butene as a major component; and combinations thereof. Preferred amorphous polyalphaolefin polymers include atactic polypropylene, propylene-ethylene amorphous copolymers, and propylene-1-butene amorphous copolymers. Useful silane functional amorphous polyalphaolefin polymers include, e.g., copolymers and terpolymers derived from alpha olefin monomers having from 4 to 10 carbon atoms in an amount from 0% by weight to 95% by weight (or even from 3% by weight to 95% by weight), propane in an amount from 5% by weight to 100% by weight (or even from 5% by weight to 97% by weight), and ethane in an amount from 0% by weight to 20% by weight as described, e.g., in U.S. Pat. No. 5,994,474, and incorporated herein.

Useful silane functional metallocene catalyzed polyolefins include, e.g., homopolymers of ethylene, homopolymers of olefin monomers having from 3 to 8 carbon atoms, and interpolymers that include at least two olefin monomers having from 2 to 8 carbon atoms.

Suitable silanes for grafting on to the polyolefin backbone include those having two or three alkoxy groups attached directly to the silicon and at least one olefinic double bond containing moiety. Suitable examples include vinyltrimethoxysilane, vinyltriethoxysilane, vinyl tris(2-methoxyethoxy)silane, 3-methacryloxypropyltrimethoxysilane, 3-methacryloxypropyltriethoxysilane, vinyldimethylmethoxysilane and vinylmethyldibutoxysilane. A useful amount of silane for grafting on to the polyolefin is from about 0.1% by weight to about 10% by weight, from about 2% by weight to about 6% by weight, or even from about 3% by weight to about 5% by weight, based on the weight of the amorphous polyalphaolefin.

Any known method for grafting silane onto the polyolefin can be used including, e.g., solution and melt (e.g., using an appropriate amount of a free-radical donor) methods. Useful methods of preparing silylated amorphous polyalphaolefins are described, e.g., in U.S. Pat. No. 5,994,474 and DE 40 00 695, and incorporated herein. Suitable examples of free-radical donors include diacyl peroxides such as dilauryl peroxide and didecanoyl peroxide, alkyl peresters (e.g., tert-butyl peroxy-2-ethylhexanoate), perketals (e.g., 1,1-di(tert-butylperoxy)-3,3,5-trimethylcyclohexane and 1,1-di(tert-butylperoxy)cyclohexane), dialkyl peroxides (e.g., tert-butyl cumyl peroxide, di(tert-butyl) peroxide and dicumyl peroxide), C-radical donors including, e.g., 3,4-dimethyl-3,4-diphenylhexane and 2,3-dimethyl-2,3-diphenylbutane, and azo compounds (e.g., 2,2′-azodi(2-acetoxypropane)).

Useful silane functional amorphous polyalphaolefins are commercially available under the VESTOPLAST trade designation from Evonik Industries AG, Germany including, e.g., VESTOPLAST 206V and VESTOPLAST 2412 silane functional amorphous polyalphaolefins.

Useful silane functional metallocene catalyzed polyolefins are commercially available under the trade designations LICOCENE PE SI 3361 TP and LICOCENE PP from Clariant AG (Switzerland).

Other useful silane functional polyolefins include silane grafted Affinity polymer and silane grafted Infuse polymer from Dow Chemical.

The amount of silane functional polyolefin in the composition will depend on its molecular weight and functionality, but will typically be from 1-80 wt %, advantageously 3-55 wt %, and more advantageously from 10-35 wt %, based on the total weight of the adhesive composition.

The silane reactive hot melt adhesive composition can comprise one or more silane modified reactive plasticizers. The silane modified reactive plasticizer has an organic backbone, bearing one or more terminal or pendant silane or alkoxylated silane groups. The silane groups are hydrolyzed by water to silanol groups, which can condense with each other or with reactive species on the adherent surfaces. The silane modified reactive plasticizer may be prepared with one or more of a variety of polymer backbones such as polyurethane, polyether, polyester, polycaprolactone, polyacrylate, polybutadiene, polycarbonate, polyamide, polythioether and the like. Advantageous backbones for the silane modified reactive plasticizer include polyurethane, polyether and acrylate modified polyether (prepared for instance as described in U.S. Pat. No. 6,350,345, the contents of which are incorporated reference). In some embodiments the silane modified reactive plasticizer is free of urethane bonds. In some embodiments the silane modified reactive plasticizer backbone is free of silicon atoms. The silane modified reactive plasticizer can be a low modulus silane modified reactive plasticizer having a Young's modulus for the cured, neat polymer lower than 50 psi; a high modulus silane modified reactive plasticizer having a Young's modulus for the cured, neat polymer equal or greater than 50 psi; or a combination of low modulus silane modified reactive plasticizer and high modulus silane modified reactive plasticizer.

In some embodiments the silane modified reactive plasticizer can be represented by the formula

R-[A-Si(CₓH₂ₓ₊₁)ₙ(OC_{y}H_{2y+1})₃₋ₙ]_{z}

wherein R is the organic backbone;

A is a linkage that links the silane to polymer backbone R;

n=0, 1 or 2;

x and y are, independently a number from 1 to 12.

The number of silane groups z will preferably be more than one per molecule (to generate a fully cured network), and more preferably at least two per molecule. More preferably, the silane functional polymer is telechelic or end-functionalized, where most or all the ends are silane functional. The number of silyl ether groups per silane end group, 3-n, is preferably 2 or 3 (n=1 or 0). The silane reactive hot melt adhesive composition cures during exposure to water or moisture, when the silane groups are hydrolyzed to silanol groups which can condense with each other or with reactive species on the adherent surfaces. Silane modified reactive plasticizers can have a number average molecular weight in the range of 500 to 100,000 Mn; advantageously 1,000 to 100,000 Mn; and more advantageously 2,000 to 100,000 Mn.

Silane modified reactive plasticizers are commercially available, for example, from Momentive Performance Material under the trade name SPUR+, from Henkel Corporation under the trade name FLEXTEC, from Kaneka Corporation under the trade name MS polymer and SILIL polymer, from Dow Chemical under the trade name Vorasil, from Wacker Chemie under the trade name Geniosil, from Risun Polymer Inc. under the trade name Risun and from Bayer MaterialScience under the trade name Baycoll 2458.

The silane modified reactive plasticizer is advantageously liquid at room temperature to provide more rapid reaction of the silane end groups in the silane reactive hot melt adhesive composition and to aid mobility of the reactive sites and thus increase the potential for covalent reaction with the surface of one or both substrates.

The amount of silane modified reactive plasticizer in the composition will depend on its molecular weight and functionality, but will typically be from 0-80 wt %, advantageously 0-60 wt %, and more advantageously from 15-40 wt %, based on the total weight of the adhesive composition.

The silane reactive hot melt adhesive composition can optionally comprise a controlled amount of acidic functional wax. By “acidic functional wax” it is meant that the wax includes a functional moiety that is acidic. The acidic functional wax can have terminal or pendant acidic functional moieties.

Ullmann's Encyclopedia of Industrial Chemistry, the contents of which are incorporated by reference herein, describes waxes. Examples of types of waxes that may be used include natural waxes, partially synthetic waxes and fully synthetic waxes. Natural waxes are formed through biochemical processes and are products of animal or plant metabolism. Partially synthetic waxes are formed by chemically reacting natural waxes. Fully synthetic waxes are prepared by polymerizing low molar mass starting materials such as carbon, methane, ethane or propane. The two main groups of fully synthetic waxes are the Fischer—Tropsch waxes and polyolefin waxes such as polyethylene wax, polypropylene wax and copolymers thereof.

Acidic functional groups are added to the wax molecule by, for example, grafting synthetic waxes with an acidic moiety such as carboxylic acid or maleic anhydride or by cleavage of the esters and/or oxidation of the alcohols in partially synthetic waxes. Acidic functional waxes can have a saponification number (mg KOH/gm wax) of less than about 90 and more advantageously from about 5 to about 30. Some useful acid functional maleated waxes can have about 50% to about 95% of maleic anhydride moieties bound to the wax backbone with the remaining with the remaining maleic anhydride content not bound to the wax backbone.

Acidic functional waxes are available commercially, for example from Clariant International Ltd, Switzerland; EPChem International Pte Ltd, Singapore; Honeywell International Inc., U.S. and Westlake Chemical Corp, U.S. Advantageous acid functional waxes are the maleated polypropylene waxes. One useful maleated polypropylene wax is A-C 1325P available from Honeywell International Inc. Another useful maleated polypropylene wax is Epolene E-43 available from Westlake Chemical Corp.

An effective amount of acid functional wax is the amount of acid functional wax that will increase green strength of a silyl reactive hot melt adhesive composition without deleteriously degrading other properties of that composition. The silane reactive hot melt adhesive composition will contain 0 to about 30 wt % of acid functional wax. Advantageously, the silane reactive hot melt adhesive composition will contain about 0.5 to about 10 wt % of acid functional wax.

The silane reactive hot melt adhesive composition can optionally comprise an effective amount of basic functional wax. By “basic functional wax” it is meant that the wax includes at least one functional moiety that is basic, for example amide moieties or amine moieties. The basic functional wax can have terminal, within the backbone, or pendant basic functional moieties. Basic functional groups are added to the wax molecule by, for example, grafting synthetic waxes with a basic moiety such as amine or amide. Basic functional groups can also be introduced by reacting molecules with basic functionality into the wax molecule.

Basic functional waxes are available commercially, for example from Honeywell International Inc., U.S. and Vertellus Specialties Inc., Greensboro, N.C. and Crayvallac Inc. Advantageous basic functional waxes are the amine and amide functional waxes. Useful basic functional waxes include ACumist from Honeywell International Inc. and Paricin 220 from Vertellus Specialties Inc, etc.

An effective amount of basic functional wax is the amount of basic functional wax that will increase green strength of a reactive hot melt adhesive composition comprised of a silane modified reactive plasticizer and acid functional wax without deleteriously degrading other properties of that composition. Surprisingly, while some amount of basic functional wax can improve green strength of the hot melt adhesive composition the use of too much basic functional wax may deleteriously degrade properties of the composition such as cured strength. Thus, the amount of basic functional wax in the silane reactive hot melt adhesive composition must be kept in a controlled range. The silane reactive hot melt adhesive composition can contain about 0 wt % to about 15 wt % of basic functional wax based on the total weight of the adhesive composition.

The silane reactive hot melt adhesive composition can optionally comprise tackifier. The choice of tackifier will depend on the backbone of the silane modified reactive plasticizer. The tackifier choices include natural and petroleum-derived materials and combinations thereof as described in C. W. Paul, “Hot Melt Adhesives,” in Adhesion Science and Engineering-2, Surfaces, Chemistry and Applications, M. Chaudhury and A. V. Pocius eds., Elsevier, New York, 2002, p. 718, incorporated by reference herein.

Useful tackifier for the adhesive composition of the invention includes natural and modified rosin, aromatic tackifier or mixtures thereof. Useful natural and modified rosins include gum rosin, wood rosin, tall oil rosin, distilled rosin, hydrogenated rosin, dimerized rosin, resinates, and polymerized rosin; glycerol and pentaerythritol esters of natural and modified rosins, including, for example as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin, and maleic anhydride modified rosin ester, etc. Examples of commercially available rosins and rosin derivatives that could be used to practice the invention include Sylvalite RE 100, RE100XL, Sylvares RE 115, Sylvatac RE4291, available from Arizona Chemical; Dertocal 140 from DRT; Limed Rosin No. 1, GB-120; Pinecrystal KE-100 and Pencel C from Arakawa Chemical, and Komotac 2100 and 2110 from Komo Resins, etc. One preferred natural and modified rosin is a rosin ester tackifier such as Pentalyn H, available from Pinova Inc. Another preferred rosin ester tackifier is Teckros H95, available from Teckrez Inc. Useful aromatic tackifiers include styrenic monomers, styrene, alpha-methyl styrene, vinyl toluene, methoxy styrene, tertiary butyl styrene, chlorostyrene, coumarone, indene monomers including indene, and methyl indene. Preferred are aromatic hydrocarbon resins that are phenolic-modified aromatic resins, C₉ hydrocarbon resins, aliphatic-modified aromatic C₉ hydrocarbon resins, C₉ aromatic/aliphatic olefin-derived and available from Sartomer and Cray Valley under the trade name Norsolene and from Rutgers series of TK aromatic hydrocarbon resins. Other preferred aromatic tackifiers are alpha-methyl styrene types such as Kristalex 3100, Kristalex 3115, Kristalex 5140 or Hercolite 240, all available from Eastman Chemical Co; Escorez 1000 series, 2000 series, 5300 and 5400 series from Exxon Mobile Inc; Eastotac H series from Eastman Chemical Inc.

If used the tackifier component will usually be present in an amount greater than 1 wt %. The tackifier component will typically be present in the amount of from about 1 to about 50 wt %, advantageously from about 10 to about 40 wt %, more advantageously from about 15 to about 35 wt %, based on the total weight of the adhesive composition.

The silane reactive hot melt adhesive composition can optionally comprise an acrylic polymer or copolymer. The acrylic polymer can improve green strength of the cooled hot melt adhesive composition. The acrylic polymer can be either a silane-reactive polymer or non-reactive polymer. A silane reactive polymer comprises groups such as carboxylic acid, amine, thiol and hydroxyl that react with silane moieties such as those on the silane modified polyolefin and/or the silane modified reactive plasticizer. A preferred silane reactive group is carboxylic acid. A non-silane reactive acrylic polymer does not include groups that are reactive with the silane modified reactive plasticizer.

Useful reactive acrylic polymers include the ELVACITE products from Dianal Inc (formerly Lucite, Inc). Preferred examples include ELVACITE 4197 and ELVACITE 2903 are solid acrylic copolymer comprising both acid and hydroxyl silane reactive groups.

The amount of solid acrylic polymer in the adhesive composition will depend on a number of factors, including the glass transition temperature and molecular weight of the acrylic polymer, but can be present in an amount of from about 0 wt % to about 35 wt %, based on the total weight of the adhesive composition.

The silane reactive hot melt adhesive composition can optionally comprise a catalyst. Suitable curing agents for the silane groups are described in U.S. Patent Publication No. 2002/0084030, and incorporated by reference herein. Exemplary catalyst includes bismuth compounds such as bismuth carboxylate; organic tin catalysts such as dimethyltin dineodecanoate, dibutyltin oxide, dibutyltin dilaurate and dibutyltin diacetate; titanium alkoxides (TYZOR® types, available from DuPont); tertiary amines such as bis (2-morpholinoethyl) ether, 2,2′-Dimorpholino Diethyl Ether (DMDEE) and triethylene diamine; zirconium complexes (KAT XC6212, K-KAT XC-A209 available from King Industries, Inc.); aluminum chelates (K-KAT 5218, K-KAT 4205 available from King Industries, Inc.), KR types (available from Kenrich Petrochemical, Inc.); and other organometallic compounds based on Zn, Co, Ni, and Fe and the like. If used, the level of catalyst in the silane reactive hot melt adhesive composition will depend on the type of catalyst used, but can range from about 0 to about 5 wt %, advantageously from about 0.05 to about 3 wt % and more advantageously from about 0.1 to about 1.5 wt %, based on the total weight of the adhesive composition.

The silane reactive hot melt adhesive composition can optionally comprise a moisture scavenger to extend pot life, such as vinyl trimethoxy silane or methacryloxypropyltrimethoxysilane. If used, the level of moisture scavenger employed can be from 0 wt % to 5 wt % and preferably from 0.5 wt % to 2 wt %, based on the total weight of the adhesive composition.

The adhesive composition can optionally comprise an adhesion promoter or coupling agent which promotes bonding of the composition to a substrate. Examples are described in: Michel J. Owen, “Coupling agents: chemical bonding at interfaces”, in Adhesion Science and Engineering-2, Surfaces, Chemistry and Applications, M. Chaudhury and A. V. Pocius eds., Elsevier, New York, 2002, p. 403, incorporated by reference herein. Preferred adhesion promoters include organo-silanes which can link the silane-functional polymer to the surface such as amino silanes and epoxy silanes. Some exemplary aminosilane adhesion promoters include 3-aminopropyltrimethoxysilane, 3-aminopropyltriethoxysilane, N-(2-aminoethyl-3-aminopropyl)trimethoxysilane, 3-aminopropylmethyldiethoxysilane, 4-amino-3,3-dimethylbutyltrimethoxysilane, N-(n-butyl)-3-aminopropyltrimethoxysilane, 1-butanamino-4-(dimethoxymethylsilyl)-2,2-dimethyl, (N-cyclohexylaminomethyl)triethoxysilane, (N-cyclohexylaminomethyl)-methyldiethoxysilane, (N-phenylaminoethyl)trimethoxysilane, (N-phenylaminomethyl)-methyldimethoxysilane or gamma-ureidopropyltrialkoxysilane. Aminosilanes with oligomeric structures such as Sivo 203 and Dynasylan 1146 from Evonik Corp. Particularly preferred amino silanes include 3-aminopropyltrimethoxysilane, 3-aminopropyltriethoxysilane, and N-Butyl-3-(trimethoxysilyl)propylamine. Some exemplary epoxy silane adhesion promoters include 3-glycidyloxypropyltrimethoxysilane, 3-glycidyloxypropyltriethoxysilane or beta-(3,4-epoxycyclohexyl)ethyltrimethoxysilane. Other silane adhesion promoters include mercaptosilanes. Some exemplary mercaptosilane adhesion promoters include 3-mercaptopropyltrimethoxysilane, 3-mercaptopropylmethyldimethoxysilane or 3-mercaptopropyltriethoxysilane. If used, the level of adhesion promoter employed can be from 0 wt % to about 15 wt %, preferably 0.01 wt % to 10 wt % and more preferably 0.1 wt % to 5 wt %. The adhesion promoter, if more reactive to moisture than the silane modified reactive plasticizer, can also serve as a moisture scavenger.

The silane reactive hot melt adhesive composition can optionally comprise conventional additives known to a person skilled in the art. Conventional additives which are compatible with a composition according to this invention may simply be determined by combining a potential additive with the composition and determining if they remain homogenous. Non-limiting examples of suitable additives include, without limitation, fillers, plasticizers, defoamers, rheology modifiers, air release agents, flame retardants and combinations thereof.

The total level of additives will vary depending on amount of each particular additive needed to provide the silane reactive hot melt adhesive composition with desired properties. The level of additives can be from 0 to 50%.

The silane reactive hot melt composition is free of elastomeric compounds such as thermoplastic elastomers.

An exemplary silane reactive hot melt adhesive composition is shown below.

| component | range (wt %) | preferred range (wt %) |
|---|---|---|
| silane functional polyolefin | 1-80 | 10-35 |
| silane modified reactive plasticizer | 0-80 | 15-40 |
| acidic functional wax | 0-30 | 0.5-15 |
| basic functional wax | 0-15 | 0-15 |
| tackifier | 0-50 | 15-35 |
| acrylic polymer | 0-35 | 0-35 |
| catalyst | 0-5 | 0.1-1.5 |
| moisture scavenger | 0-5 | 0.5-2 |
| adhesion promoter | 0-15 | 0.1-5 |
| additives | 0-50 | 0-50 |

The silane reactive hot melt adhesive composition is preferably free of water and/or solvent in either the solid and/or molten form.

The silane reactive hot melt adhesive composition can be prepared by mixing the tackifier, acrylic polymer, wax and other non-reactive components with heat until homogeneously blended. The mixer is placed under vacuum to remove moisture followed by heated mixing of the reactive components to the blended non-reactive components.

The silane reactive hot melt adhesive compositions will be solid at room temperature. The silane reactive hot melt adhesive compositions can be used to bond articles together by heating the silane reactive hot melt adhesive composition to a molten or liquid state; applying the molten hot melt adhesive composition to a first article; and bringing a second article in contact with the molten composition applied to the first article. After application of the second article the silane reactive hot melt adhesive composition is subjected to conditions that will allow it to solidify, bonding the first and second articles. Solidification occurs when the liquid melt is subjected to a temperature below the melting point, typically room temperature. Bonding strength based on solidification and before full cure is referred to as green strength. After solidification the adhesive is exposed to conditions such as surface or atmospheric moisture to cure the solidified composition to an irreversible solid form.

The silane reactive hot melt adhesive compositions are useful for bonding articles composed of a wide variety of substrates (materials), including but not limited to wood, metal, polymeric plastics, glass, textiles and composites. Non-limiting uses include use in the manufacture of footwear (shoes), use in the manufacture of doors including entry doors, garage doors and the like, use in the manufacture of panels and flooring, use in bonding components on the exterior of vehicles, and the like.

Application temperatures of the silane reactive hot melt adhesive compositions are determined by the thermal stability of the composition and the heat sensitivity of the substrates. Preferred application temperatures are above 120° C. and below 170° C., more preferably below 150° C., and most preferably below 140° C.

The silane reactive hot melt adhesive compositions may be then applied in molten form to substrates using a variety of application techniques known in the art. Examples includes hot melt glue gun, hot melt slot-die coating, hot melt wheel coating, hot melt roll coating, melt blown coating, spray and the like. In preferred embodiments the hot melt adhesive composition is applied to a substrate using hot melt roll coater or extruded onto a substrate. In another preferred embodiments the hot melt adhesive composition is applied to a substrate by using spray nozzle.

The invention is further illustrated by the following non-limiting examples.

### Examples

The following tests were used in the Examples.

Acid number (ASTM D-1386)—Standard Test Method for Acid Number (Empirical) of Synthetic and Natural Waxes

Saponification number (ASTM D-1387)—Standard Test Method for Saponification Number (Empirical) of Synthetic and Natural Waxes

Viscosity—viscosity was measured using a Brookfield viscometer with a Thermosel heating unit and spindle 27. Desirably, viscosity of the silane reactive hot melt adhesive composition should be 5,000 to 50,000 cps at 250° F.

Final (cured) strength by Lap Shear Adhesion Test (TLS)—The adhesive was applied to a clean, untreated polypropylene substrate. A stainless steel drawdown applicator (BYK-Gardner) was used to obtain a controlled thickness of 0.020 inches. Glass bead spacers 0.010 in thick were sprinkled on top of the adhesive layer to control the final bondline thickness. Clean, untreated polypropylene strips 1 inch by 4 inches were bonded to the applied adhesive with an overlapping area of 1 inch by 1 inch using hand pressure. The finished bonds were conditioned at 72° F./50% RH for either one day or two weeks before testing to allow for full moisture cure. Tensile samples were pulled along the long axis at 0.5 inches/min until failure in an Instron tensile test machine either at room temperature. Desirably, final strength of the silane reactive hot melt adhesive composition should be greater than 60 psi at room temperature and greater than 20 psi at 180° F.

Green Strength by Cantilever Pull Test (CPT)—Two, 12 inch by 2 inch by 0.5 inch thick freshly planed (within 24 hours) pine substrates are provided. One substrate is roll coated with 10 grams/foot² of molten adhesive. The second specimen is placed on the coated specimen so that there is a 3 inch by 2 inch overlap area and the overlapping area is lightly pressed. The bonded substrates are allowed to sit for a short time (typically 5 minutes, 1 hour or 2 hours) to allow the adhesive to solidify. One substrate is fixed and an increasing force is applied to the other end in the thickness direction (perpendicular to the length and width directions) until the bond fails. Force at failure in pounds is recorded.

Working life on roll coater—The time required for the molten silane reactive hot melt composition when exposed to atmospheric moisture of 20% to 80% relative humidity to gel sufficiently to require removal from the roller coating apparatus. Working life is visually determined by formation of gelled lump portions in the molten silane reactive hot melt composition of about 2 to 6 inches.

Tack free time—the time it takes for applied adhesive to become tack free from the point of application. The degree of tackiness is measured by using finger press touch and subjectively evaluating whether the adhesive is tacky to the touch.

The following materials were used in the Examples.

A-C 1325P a maleated polypropylene wax available from Honeywell International Inc. The manufacturer states that A-C 1325P has 78% bound maleic anhydride; a saponification number of 18 mg KOH/gm wax; and a viscosity of 1600 cps at 190° C.

DMDEE is a bis (2-morpholinoethyl) ether available from VWR Inc.

Dynasylan 1189 is a bifunctional silane possessing a reactive secondary amine and hydrolyzable methoxysilyl groups, available from Evonik Industries AG.

Dynasylan AMMO is a bifunctional organosilane possessing a reactive primary amine and hydrolyzable inorganic methoxysilyl groups, available from Evonik Industries AG.

Dynasylan MEMO is a methacrylfunctional silane, available from Evonik Industries AG.

Elvacite 4197 is a solid acrylic polymer having carboxyl and hydroxyl functional groups available from Dianal Acrylics.

Epolene E43 is a maleated polypropylene wax available from Westlake Chemical Corp.

Escorez 5320 is a hydrogenated polycyclopentadiene tackifier, available from ExxonMobil.

Foral 105 is a hydrogenated pentaerythritol ester tackifier, available from Pinova Inc.

Kristalex 3100 is an alpha-methyl styrene tackifier, available from Eastman Chemical Co.

Licocene PP3602 is a silane functional metallocene catalyzed polyolefin, available from Clariant AG.

MAX 951 is a low modulus silane terminated polyether, available from Kaneka Corp.

MAX 923 is a high modulus silane terminated polyether, available from Kaneka Corp.

Pentalyn H is a hydrogenated pentaerythritol ester tackifier, available from Pinova Inc.

Regalite R1090 is a hydrogenated polycyclopentadiene tackifier, available from Eastman Chemical Co.

Resiflow LF is an acrylic copolymer based defoamer available from Estron Chemical Co.

BYK-A 515 is defoamer from Altana Co.

Sylvatec RE4291 is a modified rosin ester tackifier available from Arizona Chemical.

Tecros H95 is a hydrogenated rosin ester tackifier, available from Teckrez Inc.

Vestoplast 206 is a silane functional amorphous polyolefin available from Evonik Industries AG.

Vestoplast 750 is a propene-rich amorphous polyolefin copolymer available from Evonik Industries AG.

Samples were made using the following general procedure. Into a reactor vessel charge defoamer, tackifiers, acrylic polymer, wax. Heat reactor vessel until interior reaches about 300° F. and mix until all ingredients are fully melted and blended. Place the reactor vessel under vacuum for about 1 hour. Warm the silane functional polyolefin and silane modified reactive plasticizer to about 250° F. Add the silane functional polyolefin and silane modified reactive plasticizer into the reactor vessel and mix for 15 minutes. Place the reactor vessel under vacuum for about 1 hour while maintaining temperature. Break vacuum and add moisture scavenger and adhesion promoter into the reactor vessel and mix for 10 min. Add catalyst to the reactor vessel and mix for 15 min. Collect the composition, let cool to room temperature and seal under an inert atmosphere to exclude moisture.

### Examples

Sample (parts by weight)

| Material | A | 1 |
|---|---|---|
| silane functional polyolefin¹ | 0 | 105 |
| silane modified reactive plasticizer² | 280 | 240 |
| acrylic polymer³ | 160 | 160 |
| tackifier⁴ | 170 | 140 |
| tackifier⁵ | 40 | 70 |
| acid functional wax⁶ | 16 | 20 |
| silanes⁷ | 6 | 6 |
| defoamer⁸ | 2.8 | 2.8 |
| adhesion promoter⁹ | 1.8 | 2 |
| catalyst¹⁰ | 1.6 | 1 |
| Total | 678 | 817 |

¹Vestoplast 206
²MAX951
³Elvacite 4197
⁴Krystalex 3100
⁵Pentalyn H
⁶A-C 1325P
⁷Dynasylan MEMO
⁸BYK-A 515
⁹Dynasylan AMMO
¹⁰DMDEE

Samples A and 1 are both solid at room temperature, translucent with pale yellow color. Properties are shown below.

| | Test | |
|---|---|---|
| | A | 1 |
| Viscosity (cps at 250° F.) | 11750 | 23600 |
| Open time (minutes) | 2 | 2 |
| Roller stability (minutes) | 60 | 55 |
| Tack free time (minutes) | >90 | 8 |
| Green Strength by Cantilever Pull Test (CPT) | | |
| (pounds) | | |
| 5 minutes | 18.5 | 25.5 |
| 60 minutes | 28 | 34 |
| 120 minutes | 31.5 | 46 |
| Lap Shear Adhesion Test (TLS) | | |
| (polypropylene substrates, room temperature, cure | 20.4 | 38.4 |
| 24 hours at ambient conditions¹) (pounds) | | |
| (polypropylene substrates, room temperature, cure 2 | 52.5 | 70 |
| weeks at ambient conditions¹) (pounds) | | |

¹ambient conditions are a temperature of about 23° C. and relative humidity of about 50%.

Addition of a silane functional polyolefin to the mixture improves properties. For example, the green strength is improved as shown by the desirably higher Cantilever Pull Test (CPT) results. Sample 1 had a very surprisingly reduced tack free time. Sample 1 also had improved adhesion to non-polar substrates as shown by the desirably higher adhesion on untreated polypropylene substrates in the Lap Shear Adhesion Test (TLS).

| | Sample (parts by weight) | | | | | |
|---|---|---|---|---|---|---|
| Material | 2 | 3 | 4 | 5 | 6 | 7 |
| silane functional polyolefin¹ | 35 | 70 | 70 | 140 | 70 | 105 |
| silane modified reactive | 280 | 280 | 210 | 140 | 240 | 175 |
| plasticizer² | | | | | | |
| acrylic polymer³ | 160 | 160 | 160 | 160 | 160 | 160 |
| tackifier⁴ | 170 | 170 | 170 | 170 | 170 | 170 |
| tackifier⁵ | 40 | 40 | 40 | 40 | 40 | 40 |
| acid functional wax⁶ | 20 | 20 | 20 | 20 | 20 | 20 |
| silane⁷ | 6 | 6 | 6 | 6 | 6 | 6 |
| silane⁸ | 2 | 2 | 2 | 2 | 2 | 2 |
| defoamer⁹ | 2.8 | 2.8 | 2.8 | 2.8 | 2.8 | 2.8 |
| catalyst¹⁰ | 1 | 1 | 1 | 1 | 1 | 1 |
| Total | 752 | 752 | 682 | 682 | 712 | 682 |

¹Vestoplast 206
²mixture of Max 951 and Max 923
³Elvacite 4197
⁴Krystalex 3100
⁵Tecros H 95
⁶AC 1325P
⁷Dynasylan MEMO
⁸Dynasylan AMMO
⁹BYK A515
¹⁰DMDEE

Samples 2-7 were all solid at room temperature, translucent with pale yellow color. Properties are shown below.

| | Test | | | | | |
|---|---|---|---|---|---|---|
| | 2 | 3 | 4 | 5 | 6 | 7 |
| Viscosity | 9600 | 12400 | 17700 | 57400 | 15900 | 42200 |
| (cps at 250° F.) | | | | | | |
| Open time | 2 | 2 | 1 | 0 | 1 | 0 |
| (minutes) | | | | | | |
| Roller stability | 42 | 60 | 55 | 30 | 50 | 45 |
| (minutes) | | | | | | |
| Tack free time | | | | | | |
| (min) | | | | | | |
| Green Strength | | | | | | |
| (CPT) | | | | | | |
| (pounds) | | | | | | |
| 5 minutes | 22.5 | 18.5 | 27.5 | N/A | 24.5 | 24.5 |
| 60 minutes | 24.5 | 15 | 39 | | 27.5 | 23 |
| 120 minutes | 25.5 | 22 | 36 | | 34.5 | 45 |

Viscosity rise vs time

| | Viscosity (cps at 250 F.) | | | | | |
|---|---|---|---|---|---|---|
| Material | 2 | 3 | 4 | 5 | 6 | 7 |
| 0 minutes | 9750 | 12950 | 17150 | 92750 | 14650 | 26200 |
| 15 minutes | — | — | 17350 | 69500 | 15700 | 39300 |
| 30 minutes | 9600 | 12400 | 17700 | 57400 | 15900 | 42200 |
| 45 minutes | — | — | 17850 | 57500 | 16550 | 42700 |
| 60 minutes | 10100 | 12900 | 18100 | 57900 | 16500 | 44400 |
| 90 minutes | 10500 | 13250 | 18600 | 58700 | 16800 | 47800 |
| 120 minutes | 10650 | 13700 | 19050 | 59500 | 17000 | 51900 |
| 150 minutes | 10950 | 14200 | 19350 | 60700 | 17250 | 53100 |
| 180 minutes | 11050 | 14550 | 19900 | 61700 | 17650 | 53800 |
| 210 minutes | 11250 | 15050 | — | 62700 | 17900 | 54700 |
| 240 minutes | — | — | — | — | 18050 | 54800 |

The initial viscosity drop from 0 min to about 30 minutes in Examples 2, 3, 5 is believed due to shear thinning of molten hot melt material before it had stabilized. As shown in the table, as the amount of silane functional polyolefin increases, the product is setting faster and therefore has shorter open time. For Samples 5 and 7, their open time is too short and viscosity is too high and therefore the formulations of Samples 5 and 7 cannot be used for roll coating applications.

| | Sample (parts by weight) | | | | | |
|---|---|---|---|---|---|---|
| Material | 8 | 9 | 10 | 11 | 12 | 13 |
| silane functional polyolefin¹ | 70 | 105 | 35 | 35 | 80 | 105 |
| silane modified reactive | 240 | 175 | 280 | 280 | 0 | 0 |
| plasticizer² | | | | | | |
| silane modified reactive | 0 | 0 | 0 | 0 | 230 | 240 |
| plasticizer³ | | | | | | |
| acrylic polymer⁴ | 160 | 160 | 160 | 160 | 160 | 160 |
| tackifier⁵ | 0 | 105 | 170 | 170 | 170 | 170 |
| tackifier⁶ | 40 | 105 | 0 | 40 | 0 | 0 |
| tackifier⁷ | 170 | 0 | 0 | 0 | 0 | 0 |
| tackifier⁸ | 0 | 0 | 40 | 0 | 40 | 40 |
| acid functional wax⁹ | 20 | 20 | 20 | 20 | 20 | 20 |
| silane¹⁰ | 6 | 6 | 6 | 6 | 6 | 6 |
| silane¹¹ | 2 | 2 | 2 | 2 | 2 | 2 |
| defoamer¹² | 2.8 | 2.8 | 2.8 | 2.8 | 2.8 | 2.8 |
| catalyst¹³ | 1 | 1 | 1 | 1 | 1 | 1 |
| Total | 712 | 682 | 717 | 717 | 712 | 747 |

¹Vestoplast 206
²mixture of Max 951 and Max 923
³Max 951
⁴Elvacite 4197
⁵Krystalex 3100
⁶Tecros H 95
⁷Escorez 5320
⁸Sylvatec RE4291
⁹AC 1325P
¹⁰Dynasylan MEMO
¹¹Dynasylan AMMO
¹²BYK A515
¹³DMDEE

Samples 8-13 are solid at room temperature, translucent with pale yellow color. Properties are shown below.

| | Test | | | | | |
|---|---|---|---|---|---|---|
| | 8 | 9 | 10 | 11 | 12 | 13 |
| Viscosity | 67900 | 38000 | 15300 | 10800 | 20400 | 20450 |
| (cps at 250° F.) | | | | | | |
| Open time | Phase | 1 | 2 | 2 | 1 | 1 |
| (minutes) | sprt¹ | | | | | |
| Roller stability | | 60 | 45 | 50 | 40 | 45 |
| (minutes) | | | | | | |
| Tack free time | | 3 | >8 mi | >8 mi | | |
| (min) | | | | | | |
| Green Strength | | | | | | |
| (CPT) | | | | | | |
| (pounds) | | | | | | |
| 5 minutes | | 14 | 21 | 16.5 | 25.5 | 25 |
| 60 minutes | | 27 | 25.5 | 27.5 | 29.5 | 31.5 |
| 120 minutes | | 33 | 27.5 | 27 | 42 | 41 |

¹Sample 8 shows undesirable phase separation and therefore can't be used for roll coating applications.

Viscosity rise vs time

| | Viscosity (cps at 250 F.) | | | | | |
|---|---|---|---|---|---|---|
| Material | 8 | 9 | 10 | 11 | 12 | 13 |
| 0 minutes | 58100 | 46700 | 25050 | 11600 | 21950 | 26200 |
| 15 minutes | 66300 | 36500 | 15000 | 10900 | 20100 | 20450 |
| 30 minutes | 67900 | 38000 | 15300 | 10800 | 20400 | 20450 |
| 45 minutes | 68900 | 39200 | 15650 | 10850 | 20950 | 21250 |
| 60 minutes | 69500 | 40200 | 16000 | 10950 | 21250 | 21400 |
| 90 minutes | 71100 | 41500 | 16500 | 11300 | 21950 | 22350 |
| 120 minutes | 71800 | 42700 | 16900 | 11500 | 22500 | 22550 |
| 150 minutes | 73000 | 43900 | 17250 | 11950 | 23200 | 22950 |
| 180 minutes | 74900 | 44900 | 17750 | 12250 | 23750 | 23450 |
| 210 minutes | — | — | — | — | 24200 | 24400 |
| 240 minutes | — | — | 18600 | 13250 | 24700 | 24650 |

Compositions were prepared in a similar manner to the above and using silane functional polyolefin but no silane modified reactive plasticizer.

| | Sample (parts by weight) |
|---|---|
| Material | 14 |
| silane functional polyolefin¹ | 324 |
| polypropylene wax² | 135 |
| amorphous polyolefin³ | 33.8 |
| tackifier⁴ | 135 |
| tackifier⁵ | 33.8 |
| acid functional wax⁶ | 6.8 |
| defoamer⁷ | 2.7 |
| adhesion promoter⁸ | 6.8 |
| catalyst⁹ | 3.4 |
| Total | 681.3 |

¹Vestoplast 206
²LICOCENE PP3602
³Vestoplast 750
⁴Escorez 5320
⁵Regalite R1090
⁶Epolene E43
⁷Resiflow LF
⁸Dynasylan 1189
⁹DMDEE

Sample 14 is solid at room temperature, translucent with pale yellow color. Properties are shown below.

| | Test |
|---|---|
| | 14 |
| Viscosity (cps at 250° F.) | 45400 |
| Green Strength by Cantilever Pull Test (CPT) | |
| (pounds) | |
| 5 minutes | 32 |
| 60 minutes | 56 |
| 120 minutes | 60 |
| Lap Shear Adhesion Test (TLS) | |
| (polypropylene substrates, room temperature, cure | 209 |
| 24 hours) (pounds) | |
| (polypropylene substrates, room temperature, cure 2 | 244 |
| weeks) (pounds) | |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. (canceled)

2. (canceled)

3. (canceled)

4. A moisture curable, hot melt adhesive composition comprising: a silane functional polyolefin; and at least one of an acid functional wax, or one or more silane modified reactive plasticizers having a backbone structure selected from polyurethane, polyether, polyester, polyacrylate and acrylate modified polyether; and optionally a tackifier.

5. The moisture curable, hot melt adhesive composition of claim 4 comprising 0.5% to 15% of acid functional wax.

6. The moisture curable, hot melt adhesive composition of claim 4 or 5 further comprising an aminosilane adhesion promoter.

7. The moisture curable, hot melt adhesive composition of any of claims 4 to 6 further comprising an aminosilane adhesion promoter and 0.5% to 15% of acid functional wax, wherein the molar ratio of acid functionality from the acid functional wax and amino functionality of the aminosilane (R) is equal to or less than 1.8.

8. The moisture curable, hot melt adhesive composition of any of claims 4 to 7 being free of isocyanate functionality.

9. The moisture curable, hot melt adhesive composition of any of claims 4 to 8, further comprising an acrylic polymer or an acrylic copolymer; and a catalyst.

10. The moisture curable, hot melt adhesive composition of any of claims 4 to 9 comprising silane modified reactive plasticizer, wherein the silane modified reactive plasticizer is a liquid at room temperature and comprises at least one silyl group with a formula of
A-Si(CₓH₂ₓ₊₁)ₙ(OC_{y}H_{2y+1})₃₋ₙ,
wherein
A is a linkage to the silane modified reactive plasticizer backbone;
x is 1 to 12;
y is 1 to 12; and
n is 0, 1 or 2.

11. The moisture curable, hot melt adhesive composition of any of claims 4 to 10 comprising silane modified reactive plasticizer, wherein the silane functional polyolefin and the silane modified reactive plasticizer are each free of urethane linkages.

12. The moisture curable, hot melt adhesive composition of any of claims 4 to 11 comprising silane modified reactive plasticizer, wherein the silane modified reactive plasticizer has a formula
R-[A-Si(CₓH₂ₓ₊₁)ₙ(OC_{y}H_{2y+1})₃₋ₙ]_{z}
wherein
R is the backbone structure and is free of silicon atoms,
A is a linkage that links the silane group to the backbone structure R.
n=0, 1 or 2;
x and y are, independently a number from 1 to 12; and
z is at least one.

13. The moisture curable, hot melt adhesive composition of any of claims 4 to 12 comprising tackifier, wherein the tackifier is selected from at least one of fully or partially hydrogenated rosin esters.

14. The moisture curable, hot melt adhesive composition of any of claims 4 to 13 comprising tackifier, wherein the tackifier comprises an aromatic tackifier selected from the group consisting of alpha-methyl styrene resins, C₉ hydrocarbon resins, aliphatic-modified aromatic C₉ hydrocarbon resins, phenolic-modified aromatic resins, C₉ aromatic/aliphatic olefin-derived resins, and mixtures thereof.

15. The moisture curable, hot melt adhesive composition of any of claims 4 to 14 comprising silane modified reactive plasticizer, wherein the silane modified reactive plasticizer is a low modulus silane modified liquid polymer.

16. The moisture curable, hot melt adhesive composition of any of claims 4 to 15 being free of water and solvent.

17. The moisture curable, hot melt adhesive composition of any of claims 4 to 16 comprising silane modified reactive plasticizer, wherein the silane modified reactive plasticizer has a number average molecular weight in the range of 500 to 100,000 Mn.

18. A method of applying a moisture curable, hot melt adhesive composition comprising:
providing the hot melt adhesive composition of any of claims 1 to 17 in solid form at room temperature;
heating the hot melt adhesive composition to a molten state at the point of use;
applying the molten hot melt adhesive composition to a first substrate;
bringing a second substrate in contact with the molten hot melt adhesive composition applied to the first substrate;
cooling the applied molten hot melt adhesive composition to a solid state;
subjecting the cooled hot melt adhesive composition to conditions sufficient to irreversibly cure the cooled hot melt adhesive composition to form a bond between the first and second substrates.

19. An article of manufacture comprising the moisture curable, hot melt adhesive composition of any of claims 1 to 17.

20. Cured reaction products of the moisture curable, hot melt adhesive composition of any of claims 1 to 17.
